(19) United States
(12) Patent Application Publication
(10) Pub. No.: US 2017/0344984 A1
(43) Pub. Date: Nov. 30, 2017

(54) CARD PAYMENT SYSTEM AND METHOD FOR USING BODY INFORMATION

(71) Applicant: JINI CO., LTD, Jeollabuk-do (KR)

(72) Inventors: Hye Jin JEONG, Jeollabuk-do (KR); Si Hyun LEE, Jeollabuk-do (KR)

(73) Assignee: JINI CO., LTD, Jeollabuk-do (KR)

(21) Appl. No.: 15/355,135

(22) Filed: Nov. 18, 2016

(30) Foreign Application Priority Data
May 31, 2016 (KR) 10-2016-0067663

(51) Int. Cl. G06Q 20/38; G06Q 20/40; G06Q 20/10; H04L 29/06

(52) U.S. Cl. CPC G06Q 20/3829; H04L 63/0428; G06Q 20/40975; H04L 63/06; G06Q 20/102; G06Q 2220/00; H04L 2209/56

(57) ABSTRACT

A card payment system using body information and its method. A card reader, a user terminal unit and a server are connected via a communication network, cryptogram search keys and password keys are received from the user terminal unit to the server, a card information cryptogram table and a cryptogram search key table are generated. Also, the card payment system, if the first body information of a IC card and the second body information of a user of the IC card are same, checks if a card information cryptogram which is generated from the IC card's card information and the card information cryptogram cryptogram table which is stored in the server are same. Thus, the card payment system using body information can process a payment without decryption of the encrypted card information cryptogram.

### TECHNICAL FIELD

The present invention relates to a card payment system for using body information, and more particularly, to a card payment system for using body information and a method thereof which improve security in the card payment by using body information and a cryptogram search key.

### BACKGROUND ART

A biometrics-based authentication is a technology which identifies a person by unique characters of a fingerprint, an iris, a vein, a face, or etc. It also includes a human voice, a handwriting, a body type, and a manner of walking. These body informations are unique depend on a person, so it is easy to identify and there is rare risk to be lost or stolen as long as the body is not mutilated. Further, the iris and the vein are very difficult to be forged. Thus, such a biometrics-based authentication is emerging as reliable means of security in this Fin Tech era which merges information technology and finance.

However, there are many problems to be solved in the biometrics-based authentication because each body information is one and only. Especially, it is a key point to reduce user's psychological objection or concern of the body information's leakage. If the biometrics-based authentication is abused by a hacking or etc., its damage would be bigger than a leaked password.

To prevent such a damage, a card payment system needs to prevent a leakage of information in a process of encrypted card information's decryption at the same time of using body information in the card payment.

### RELATED ART DOCUMENTS

Patent Document 1: Korean Patent No. 10-0762971 (Issue date: Oct. 2, 2007)
Patent Document 2: Korean Patent No. 10-0876003 (Issue date: Dec. 26, 2008)
Patent Document 3: Korean patent Application Laid-Open Publication No. 10-2013-0008125 (publication date: Jan. 22, 2013)
Patent Document 4: Korean patent Application Laid-Open Publication No. 10-2013-0050039 (publication date: May 15, 2013)

### DISCLOSURE OF INVENTION

### Technical Problem

An object of the present invention is to provide a card payment system and its method which reduce a risk of personal information's lost, stolen, or forged using body information to strengthen security of a card payment and to process a payment without decryption of encrypted information.

Another object of the present invention is to provide the card payment system and its method which, if the first body information and the second body information which are brought from a IC card and the IC card's user are same, finds a pre-registered cryptogram of the card information using a password key and a cryptogram search key, and processes the payment if the found cryptogram and a generated cryptogram which are generated with the card information of the IC card are same.

### Technical Solution

In order to achieve the objects, an aspect of the present invention is directed to a card payment system in which a server receives a cryptogram search key and a password key from a user terminal unit, the server generates a card information cryptogram table and a cryptogram search key table, if the first and the second body information are same, a card reader transmits a card information cryptogram to the server, and the server compares the transmitted card information cryptogram and a corresponding card information cryptogram of the card information cryptogram of the table to process a payment approval.

According to the aspect of the present invention, the card payment system includes: a communication network; an IC card saving a card information and a first body information of a cardholder which are identifiable; a card reader obtaining the card information and the first body information through reading the IC card, obtaining a second body information from a user of the IC card, obtaining a user password key which is for an encryption of the card information if the first body information and the second body information are same, generating a user card information cryptogram by using the user password key, and transmitting the user password key, the user card information cryptogram and a payment information via the communication network requesting a payment approval; and a server including a cryptogram search key table where a plural password key and a plural cryptogram search key which has an access authority to a certain card information cryptogram are match one by one and a card information cryptogram table where a plural card information cryptogram which is generated by using a certain password key and a plural password key are match one by one, finding, from the cryptogram search key table, a corresponding cryptogram search key of the cryptogram search key table which corresponds to the user password key which is transmitted from the card reader, finding, from the card information cryptogram table, a corresponding card information cryptogram of the card information cryptogram table which corresponds to the corresponding cryptogram search key, processing the payment approval for the card reader if the user card information cryptogram and the corresponding card information cryptogram are same.

According to an exemplary embodiment of the aspect, the card payment system further comprises a user terminal unit which transmits the user password key to the card reader if the card reader requests an input of the user password key to the user terminal unit via the communication network.

In another exemplary embodiment of the aspect, the user terminal unit transmits the plural cryptogram search key and the plural password key to the server via the communication network for the server to generate the card information cryptogram table and the cryptogram search key table.

In another exemplary embodiment of the aspect, the card reader includes: a communication unit; a IC card reader unit obtaining the card information and the first body information through reading the IC card; a body information reader unit obtaining the second body information from the user of the IC card; a body information identifying module checking if the first body information and the second body information are same; an encryption module generating the card information cryptogram by using the user password key; and a payment processing module, receiving the user password key if the first body information and the second body information are same at the body information identifying module, providing the user password key to the encryption module, receiving the user card information cryptogram from the encryption module, receiving the payment information, requesting the payment approval to the server, and displaying a result of the payment approval if the server processes the payment approval.

In another aspect of the present invention, the present invention is directed to a method of the card payment system in which a card reader, a user terminal unit and a server are connected to each other via a communication network, finding a card information cryptogram by using IC card information, the first and second body information to process a payment approval.

According to the another aspect of the present invention, the method of the card payment system includes: generating, by a server, a cryptogram search key table where a plural password key which is to encrypt a card information of a IC card which saves the card information and a first body information and a plural cryptogram search key which has an access authority to a certain card information cryptogram which is an encryption result of a certain card information by a certain password key are match one by one and generating, by a server, a card information cryptogram table where the plural cryptogram search key and a plural card information cryptogram are match one by one; checking, by a card reader, if the first body information which is obtained from the IC card together with the card information and a second body information which is obtained from a user of the IC card are same; generating, by the card reader, a user card information cryptogram after receiving a user password key if the first body information and the second body information are same; finding, by the server, a corresponding cryptogram search key from the cryptogram search key table which corresponds to the user password key and a corresponding card information cryptogram of the card information cryptogram table which corresponds to the corresponding cryptogram search key if the card reader requests a payment approval; checking, by the server, if the user card information cryptogram which is transmitted from the card reader and the corresponding card information cryptogram are same; and processing, by the server, the payment approval if the user card information cryptogram and the corresponding card information cryptogram are same.

According to an exemplary embodiment of the aspect, in the generating of the server, the server generates the cryptogram search key table using a plural cryptogram search key which is transmitted from a user terminal unit via a communication network, and generates the card information cryptogram table using a plural password key which is transmitted from the user terminal unit via a communication network.

As another exemplary embodiment, in the generating of the card reader, the card reader requests an input of the user password key to the user terminal unit, and the user terminal unit transmits the user password key to the card reader.

It is to be understood that both the foregoing general description and the following detailed description of the present invention are exemplary and explanatory and are intended to provide further explanation of the invention as claimed.

### Advantageous Effects

As described above, the card payment system and its method of the present invention can provide reliable means of authentication by using the body information, and can prevent the leakage of information by omitting the decryption of the card information cryptogram.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a diagram illustrating a configuration of a card payment system for using body information according to an embodiment of the present invention;

FIG. 2 is a diagram illustrating a data structure of the card information and the first body information in FIG. 1 according to an embodiment of the present invention;

FIG. 3 is a diagram illustrating a configuration of the card reader in FIG. 1 according to an embodiment of the present invention;

FIG. 4 is a diagram illustrating a configuration of the server in FIG. 1 according to an embodiment of the present invention;

FIGS. 5a and 5b are the card information cryptogram table and the cryptogram search key table in FIG. 4 according to an embodiment of the present invention; and

FIG. 6 is a flowchart illustrating a processing sequence of the card payment system for using body information according to an embodiment of the present invention.

### BEST MODE FOR CARRYING OUT THE INVENTION

Exemplary embodiments of the present invention can have other modifications and variations, and the scope of this present invention should not be limited by the embodiments described below. These exemplary embodiments of the present invention are provided in order to better explain the present invention to others skilled in the art. Thus, the some of elements of the drawing are exaggerated in their shape for a clear explanation.

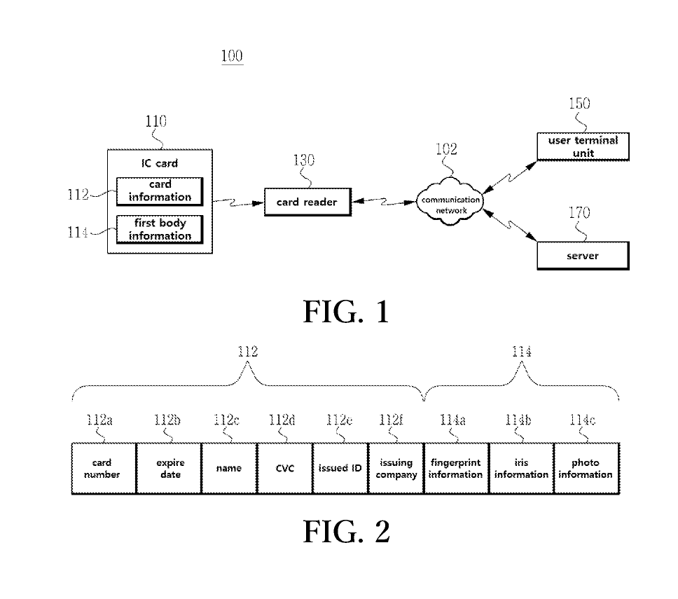

Hereinafter, embodiments of the present invention will be described in detail with reference to FIG. 1 to FIG. 6.

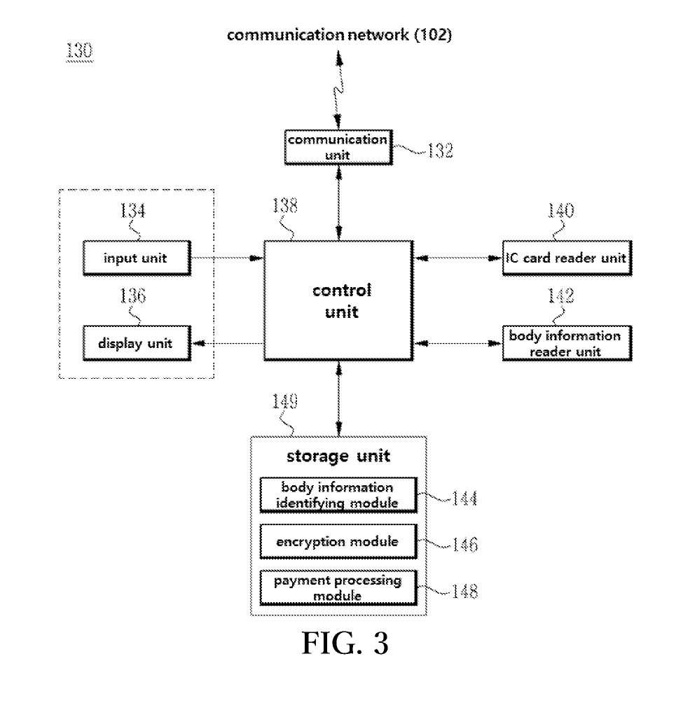

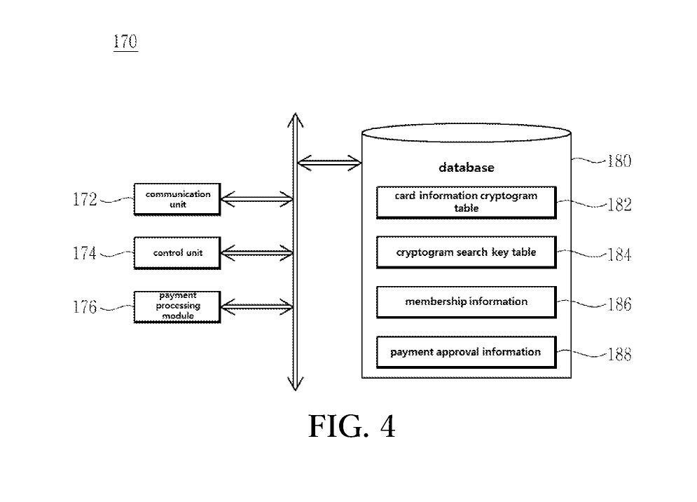

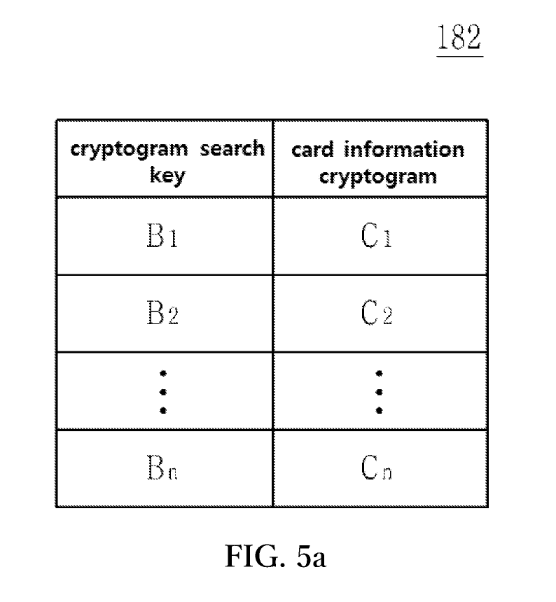

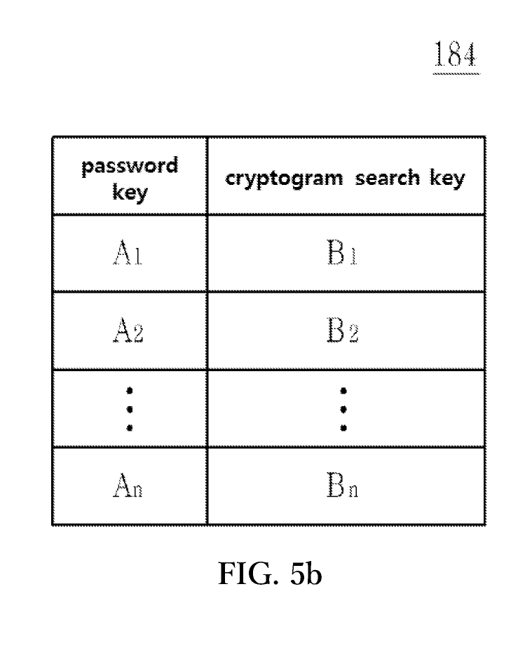

FIG. 1 is a diagram illustrating a configuration of a card payment system for using body information according to an embodiment of the present invention, FIG. 2 is a diagram illustrating a data structure of the card information and the first body information in FIG. 1, FIG. 3 is a diagram illustrating a configuration of the card reader in FIG. 1, FIG. 4 is a diagram illustrating a configuration of the server in FIG. 1, and FIGS. 5a and 5b are the card information cryptogram table and the cryptogram search key table in FIG. 4.

As shown in FIG. 1 to FIG. 5b, the card payment system of the present invention, to prevent leakage of information by omitting decryption of card information cryptogram with means of authentication which are impossible to be stolen or copied by other persons, provides a card payment system 100 for using body information which checks, by a card reader 130, if the first body information and the second body information are same, which are took from a IC card 110 and a user of the IC card 110, and compares a card information cryptogram which are transmitted from the card reader 130 to a server 170 with other card information cryptogram which are stored in a database 180 of the server 170.

Here, the card reader 130 and the server 170 are connected with each other via a communication network 102. Also, the communication network 102 may be connect with the card reader 130, a user terminal unit 150, and the server 170 via wire or wireless channel.

Specifically, the IC card 110 includes intergrated circuits, a memory which may read and write data multiple times and a processor which may encrypt data, be programmed for the IC card to be compatible with specific computer models or etc. as well as simply save data. Here, the memory saves: data which includes card information 112 such as a card number 112a, an expire date 112b, a name 112c, CVC 112d, an issued ID 112e and an issuing company 112f; and another data which includes the first body information 114 such as fingerprint information 114a, iris information 114b and photo information 114c for the card reader 130 to check with, and the memory may provide the card information 112 and the first body information 114 to the server 170. Also, the photo information 114c may include information of user's face which may be used for checking with means of face's three-dimensional shape or face's thermal distribution. Further, the first body information 114 may include vein information, voice information for a user authentication as well as the fingerprint information 114a, the iris information 114b and the photo information 114c.

The card information 112 and the first body information of the IC card 100 are encrypted and saved in the server 170 as multiple card information cryptograms. Also, at least one of the card information cryptograms which is saved in the server 170 and at least one of the card information cryptograms of the card information 112 which is read by the card reader 130 are compared for processing of a payment approval.

The card reader 130 is connected to the user terminal unit 150 and the server 170 via the communication network 102, and transmits the card information cryptogram which is encrypted from the card information 112 of the IC card 110 that are read by the card reader 130 and receives password keys which is transmitted from the user terminal unit 150. The card reader 130 includes: a communication unit 132; a control unit 138; a IC card reader unit 140; a body information reader unit 142; a body information identifying module 144; an encryption module 146; and a payment processing module 148. Also, the card reader 130 may further include an input unit 134 and a display unit 136. Here, the body information identifying module 144, the encryption module 146 and the payment processing module 148 may be included in a storage unit 149. Also, the input unit 134 and the display unit 136 may be provided as various forms of a user interface such as a touch panel, a software keypad, or etc.

The communication unit 132 is connected with the communication network 102, requests an input of a password key to the user terminal unit 150, receives the password key, and provides the password key to the control unit 138.

The control unit 138 checks if the first body information 114 which is from the IC card 110 and the second body information which is from the user of the IC card 110 are same by controlling the IC card reader unit 140, the body information reader unit 142, the storage unit 149 and a user interface, generates a card information cryptogram by encrypting the card information 112 of the IC card 110 with a password key which is transmitted from the user terminal unit 150 to the card reader 130 or input to the input unit 134, and transmits payment information which includes payment amount, the password key and the card information cryptogram, or etc. to the server 170 for processing of a payment approval.

The IC card reader unit 140 takes the card information 112 and the first body information 114 by reading the IC card 110.

The body information reader unit 142 takes the second body information from a user of the IC card 110. Here, the body information reader unit 142 may include: a fingerprint sensor which may recognize a user's fingerprint, an iris sensor which may recognize a user's iris and a face sensor which may recognize a user's face.

The body information identifying module 144 checks if the first and the second body information are same.

The encryption module 146 generates the card information cryptogram by encrypting the card information 112 of the IC card 110 with the password key which is transmitted from the user terminal unit 150 to the card reader 130 or input to the input unit 134.

The payment processing module 148 receives the password key from the user terminal unit 150 if the first and the second body information are same at the body information identifying module 144, provides the password key to the encryption module 146, and takes the card information cryptogram from the encryption module 146. Also, the payment processing module 148 receives payment information, requests a payment approval to the server 170, processes to display a result of the payment approval if the server 170 gives the result. Here, the payment processing module 148, to request the payment approval, transmits the password key which is transmitted from the user terminal unit 150 or input to the input unit 134, the card information cryptogram which is encrypted in the encryption module 146 and the payment information to the server 170.

The input unit 134 receives the payment information which includes the payment amount, the number of months for an installment plan or etc., and provides the payment information to the control unit 138.

The display unit 136 displays, by controlling of the control unit 138, the result of the payment approval which comes from the server 170.

The server 170 is connected to the card reader 130 and the user terminal unit 150 via the communication network 102, if the user terminal unit 150 transmits multiple cryptogram search keys to the server 170, matches, one by one, the cryptogram search keys with multiple card information cryptograms which are stored in the server 170 at the time of the IC card 110's issuance, saves the matched cryptogram search keys in a card information cryptogram table 182, if the user terminal unit 150 transmits multiple password keys which are different to each other to the server 170, the server matches, one by one, the password keys with the cryptogram search keys which are saved in the card information cryptogram table 182, saves the matched password keys in a cryptogram search key table 184. Here, each cryptogram search key which is transmitted from the user terminal unit 150 to the server 170 means an access authority for a certain card information cryptogram which is stored in the server 170, in other words, it is a permitted authority for a specific user, a specific program, a specific process, or a computer system in a specific computer network. The cryptogram search keys are matched one by one with the card information cryptograms which are stored in the server 170 under a certain rule such as matching in order or matching randomly. Also, the server 170, if the multiple password keys are received from the user terminal unit 150 to the server 170, brings field values of the cryptogram search keys in the card information cryptogram table 182 or brings the cryptogram search keys themselves, and processes one by one matching with the password keys under a certain rule such as matching in order or matching randomly. The card information cryptogram table 182 and the cryptogram search key table 184 which are generated by the coaching process are used for payment approval processes by a finding corresponding card information cryptogram of the card information cryptogram table 182 if a user pays with the IC card 110.

The card information cryptogram table 182 and the cryptogram search key table 184 are set up at the time of the IC card 110's issuance or the IC card 110's registration, and saved in the database 180. Also, the database 180 saves user's membership information 186 which are registered at the time of the IC card 110's issuance, such as a phone number, an address, or etc. and payment approval information 188 which is a history of approved payments.

In FIG. 4, the database 180, by the communication unit 172, is connected to the card reader 130 and the user terminal unit 150 via the communication network 102, generates informations, saves the information in the database 180, and uses the informations which is saved in the database 182. Also, the payment processing module 176 compares a card information cryptogram of the card information cryptogram table 182 with another card information cryptogram which is transmitted from the card reader 130, checks if they are same, and processes an approval or a refusal of the payment as a result of the checking.

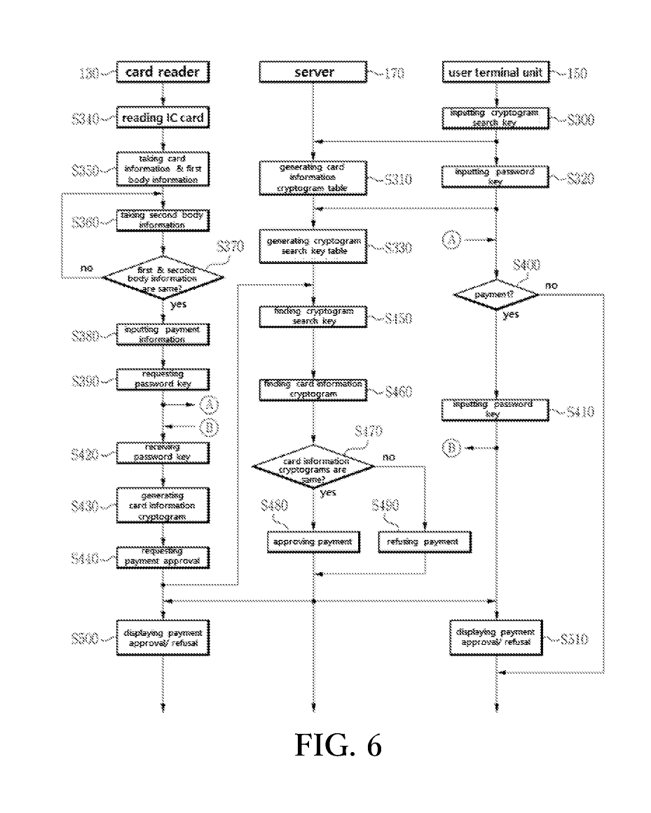

Methods of the card payment system 100 for using body information according to an embodiment of the present invention will be described specifically with reference to FIG. 6. The card payment system 100 where the card reader 130, the user terminal unit 150 and the server 170 are connected to each other via the communication network 102 processes sequences of the card payment system 100. Hereinafter, the sequences will be described in detail using the configurations of the card payment system 100 which are illustrated in FIG. 1 to FIG. 5.

FIG. 6 is a flowchart illustrating a processing sequence of the card payment system for using body information according to the present invention.

As shown in FIG. 6, in the step, S300, of the card payment system 100 of the embodiment, a user of the IC card 110 inputs multiple cryptogram search keys which are different to each other to the user terminal unit 150, and the cryptogram search keys are transmitted to the server 170 through the communication network 120.

In the step, S310, the server 170 matches multiple card information cryptograms which are saved in the server 170 at the time of the IC card 100's issuance or registration and the transmitted cryptogram search keys one by one under a certain rule such as matching in order or matching randomly, and generates the card information cryptogram table 182 where the card information cryptograms and the cryptogram search keys are matched one by one.

In the step, S320, each user of the IC card 110 input each different password key to the user terminal unit 150, and the multiple password keys which are input by multiple users are transmitted to the server 170 through the communication network 120.

In the step, S330, the server 170 processes matching of the transmitted password keys and field values of cryptogram search keys or the cryptogram search keys themselves which are included in the card information cryptogram table 182 under a certain rule such as matching in order or matching randomly, and generates the cryptogram search key table 184 where the cryptogram search key and the password keys are matched one by one.

In the step, S340, the card reader 130 reads the IC card 110.

In the step, S350, the IC card reader unit 140 takes, from the IC card 110 for the card reader 130, the card information 112 such as the card number 112a, the expire date 112b, the name 112c, the CVC 112d, the issued ID 112e or the issuing company 112f and the first body information 114 such as the fingerprint information 114a, the iris information 114b or the photo information 114c.

In the step, S360, the body information reader unit 142 takes, from the user of the IC card 112, the second body information such as the fingerprint information, the iris information or the photo information.

In the step, S370, the body information identifying module 144 checks if the first and second body information are same, if the first and second body information are same, the sequence proceeds to the step, S380, and if they are not same, the sequence proceeds to the step, S360.

In the step, S380, payment information which includes the payment amount, the number of months for an installment plan, etc. is input to the input unit 134, and the input unit 134 provides the payment information to the payment processing module 148 of the card reader 130.

In the step, S390, the payment processing module 148 requests an input of the password key to the user terminal unit 150 via the communication network 102.

In the step, S400, after the user terminal unit 150 receives the request of the password key from the payment processing module 148, if it is decided to keep proceeding the payment, the sequence proceeds to the step, S410, if not, the sequence ends.

In the step, S410, the user terminal unit 150 transmits the password key which is input by the user to the card reader 130 via the communication network 102.

In the step, S420, the communication unit 132 receives the password key, and provides the password key to the encryption module 146.

In the step, S430, the encryption module 146 generates the card information cryptogram which corresponds to the provided password key, and provides, to the payment processing module 148, the generated card information cryptogram and the password key which is provided from the communication unit 132 of the card reader 130 to the encryption module 146.

In the step, S440, the payment processing module 148 transmits the provided card information cryptogram, the password key and the payment information to the server 170 via the communication network 102 requesting the payment approval.

In the step, S450, the server 170 receives the transmitted card information cryptogram, the password key and the payment information through the communication unit 172 of the server 170, looks for a password key which is same with the transmitted password key out of password keys which are stored in the cryptogram search key table 184, finds the cryptogram search key which matches with the same password key, and provides the found cryptogram search key to the card information cryptogram table 182.

In the step, S460, the server 170 looks for a cryptogram search key of the card information cryptogram table which is same with the cryptogram search key which is found and provided out of cryptogram search keys of the cryptogram search key table 184, finds the card information cryptogram of the card information cryptogram table which matches with the same cryptogram search key of the card information cryptogram table, and provide it to the payment processing module 176.

In the step, S470, the payment processing module 176 checks if the card information cryptogram which is transmitted from the card reader 130 to the server 170 and the other card information cryptogram which is found from the card information cryptogram table 182 are same, if the transmitted card information cryptogram and the found card information cryptogram are same, the sequence proceeds to the step, S480, and if not, the sequence proceeds to the step, S490.

If the two card information cryptograms are same, in the step, S480, the payment processing module 176 processes the payment approval, and transmits the processed payment result to the card reader 130 and the user terminal unit 150. However, if the two card information cryptograms are not same, in the step, S480, the payment is refused, and it is transmitted to the card reader 130 and the user terminal unit 150.

In the step, S500, the payment processing module 148 displays, through the display unit 136, the result of the payment approval or the refusal.

In the step, S510, the user terminal unit 150 displays, through a display device (not shown in the drawing), the result of the payment approval or the refusal.

Therefore, in the card payment system 100 of the present invention, cryptogram search keys and password keys are received from the user terminal unit 150 to the server 170, the card information cryptogram table 182 which stores card information cryptograms and cryptogram search keys and the cryptogram search key table 184 which stores cryptogram search keys and password keys are generated, card information cryptogram is received from the card reader 130 to the server 170, and the received card information cryptogram and the stored card information cryptogram are compared to process a payment approval.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A card payment system comprising:
a communication network;
an IC card saving a card information and a first body information of a cardholder;
a card reader obtaining the card information and the first body information through reading the IC card, obtaining a second body information from a user of the IC card, obtaining a user password key which is for an encryption of the card information if the first body information and the second body information are same, generating a user card information cryptogram by using the user password key, and transmitting the user password key, the user card information cryptogram and a payment information via the communication network requesting a payment approval; and
a server comprising a cryptogram search key table where a plurality of password keys and a plurality of cryptogram search keys are saved as pair and a card information cryptogram table where a plurality of card information cryptograms and a plurality of password keys are saved as pair, finding, from the cryptogram search key table, a corresponding cryptogram search key of the cryptogram search key table which corresponds to the user password key which is transmitted from the card reader, finding, from the card information cryptogram table, a corresponding card information cryptogram of the card information cryptogram table which corresponds to the corresponding cryptogram search key, processing the payment approval for the card reader if the user card information cryptogram and the corresponding card information cryptogram are same.

2. The system of claim 1, wherein the card payment system further comprises a user terminal unit which transmits the user password key to the card reader if the card reader requests the user password key to the user terminal unit via the communication network.

3. The system of claim 2, wherein the user terminal unit transmits the plurality of cryptogram search keys and the plurality of password keys to the server via the communication network for the server to generate the card information cryptogram table and the cryptogram search key table.

4. The system of claim 1, wherein the card reader comprises:
a communication unit;
an IC card reader unit obtaining the card information and the first body information through reading the IC card;
a body information reader unit obtaining the second body information from the user of the IC card;
a body information identifying module checking if the first body information and the second body information are same;
an encryption module generating the card information cryptogram by using the user password key; and
a payment processing module, receiving the user password key if the first body information and the second body information are same at the body information identifying module, providing the user password key to the encryption module, receiving the user card information cryptogram from the encryption module, receiving the payment information, requesting the payment approval to the server, and displaying a result of the payment approval if the server processes the payment approval.

5. A method of a card payment system comprising:
generating, by a server, a cryptogram search key table where a plurality of password keys and a plurality cryptogram search keys are saved as pair and a card information cryptogram table where the plurality of cryptogram search keys and a plurality of card information cryptograms are saved as pair;
checking, by a card reader, if a first body information which is obtained from an IC card and a second body information which is obtained from a user of the IC card are same;
generating, by the card reader, a user card information cryptogram after receiving a user password key if the first body information and the second body information are same;
finding, by the server, a corresponding cryptogram search key from the cryptogram search key table which corresponds to the user password key and a corresponding card information cryptogram of the card information cryptogram table which corresponds to the corresponding cryptogram search key if the card reader requests a payment approval;
checking, by the server, if the user card information cryptogram which is transmitted from the card reader and the corresponding card information cryptogram are same; and
processing, by the server, the payment approval if the user card information cryptogram and the corresponding card information cryptogram are same.

6. The method of claim 5, wherein, in the generating of the server, the server generates the cryptogram search key table using a plurality of cryptogram search keys which are transmitted from a user terminal unit via a communication network, and generates the card information cryptogram table using a plurality of password keys which are transmitted from the user terminal unit via a communication network.

7. The method of claim 6, wherein, in the generating of the card reader, the card reader requests the user password key to the user terminal unit, and the user terminal unit transmits the user password key to the card reader.

8. The system of claim 3, wherein the card reader comprises:
a communication unit;
an IC card reader unit obtaining the card information and the first body information through reading the IC card;
a body information reader unit obtaining the second body information from the user of the IC card;
a body information identifying module checking if the first body information and the second body information are same;
an encryption module generating the card information cryptogram by using the user password key; and
a payment processing module, receiving the user password key if the first body information and the second body information are same at the body information identifying module, providing the user password key to the encryption module, receiving the user card information cryptogram from the encryption module, receiving the payment information, requesting the payment approval to the server, and displaying a result of the payment approval if the server processes the payment approval.
